(19) United States
(12) Patent Application Publication
(10) Pub. No.: US 2008/0280688 A1
(43) Pub. Date: Nov. 13, 2008

(54) Power transmission apparatus

(75) Inventor: Michiyasu Nosaka, Anjo-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/149,386

(22) Filed: Apr. 30, 2008

(30) Foreign Application Priority Data
May 11, 2007 (JP) 2007-127036

(51) Int. Cl. F16D 7/02

(52) U.S. Cl. 464/30

(57) ABSTRACT

A power transmission apparatus including a pulley and a hub coupled to the pulley is disclosed. An internally threaded portion formed in a hub center hole is screwed with an externally threaded portion of a rotary shaft thereby to couple the pulley to the rotary shaft. The apparatus further includes a seal member for sealing the hub center hole. The seal member includes a fixed portion having a fitting hole fitted on the forward end portion of the rotary shaft and a flange portion extending in radial direction and adapted to form a contact seal portion surrounding the hub center hole with the hub.

### BACKGROUND OF THE INVENTION

1. Field of the Invention

This invention relates to a power transmission apparatus for transmitting the turning effort, or in particular, to a power transmission apparatus suitably applicable to a compressor of an automotive air conditioning system.

2. Description of the Related Art

A power transmission apparatus including a pulley and a hub for transmitting the power to a compressor, in which the hub is screwed to the rotary shaft of the compressor, is disclosed in Japanese Unexamined Patent Publication No. 2006-153258. The power transmission apparatus of this type includes a hub-side torque limiter for protecting the belt or the like from seizing of the compressor. This power transmission apparatus is configured so that excessive torque is converted by the screwed structure of the hub and the rotary shaft into an excessive axial force which breaks the fragile part of the torque limiter. Also, in the power transmission apparatus disclosed in Japanese Unexamined Patent Publication No. 2006-153258, surface treatment is conducted or an oil or like is coated on the threaded portion in order to stabilize the operation of the torque limiter by keeping a constant friction coefficient of the threaded portion. For this reason, this power transmission apparatus further includes a seal means to prevent the intrusion of moisture or dust into the threaded portion from outside, to suppress the outflow or evaporation of the oil or the like and also to prevent corrosion of the forward end portion of the rotary shaft.

FIG. 13 is a longitudinal sectional view showing the essential parts equivalent to those of the power transmission apparatus according to a sixth embodiment of the invention disclosed in Japanese Unexamined Patent Publication No. 2006-153258. As shown in FIG. 13, the seal means 500 is in the shape of a bottomed cylinder press fitted into a central hole 230c of a torque limiter (limiter portion) 230 in such a manner as to cover the forward end portion 400a of a rotary shaft 400.

The seal means 500 of the conventional power transmission apparatus shown in FIG. 13 is press fitted into the central hole 230c of the limiter portion 230. Therefore, the outer peripheral surface of the seal means 500 may be damaged and the seal function may be adversely affected at the time of pressure fitting.

### SUMMARY OF THE INVENTION

This invention has been achieved in view of the problem of the prior art described above, and the object thereof is to provide a power transmission apparatus which is coupled by being screwed to the rotary shaft of a rotary machine and in which the reliability of sealing in the screwed coupling is improved.

This invention provides a power transmission apparatus described in each claim appended hereto as a technical means for solving the problem described above.

According to a first aspect of the invention, there is provided a power transmission apparatus comprising a pulley (1) mounted rotatably on a casing (7) of a rotary machine having a rotary shaft (4), the rotary shaft (4) including an externally threaded portion (4b) formed on the part projecting out of the casing (7) of the rotary machine, and a hub (2) coupled to the pulley (1) in such a manner as to transmit the torque to the pulley (1), the hub (2) including a hub center hole (23c) having an internally threaded portion (23f) formed along the axis of the hub, and wherein the internally threaded portion (23f) is screwed to the externally threaded portion (4b) of the rotary shaft (4) and thus coupled to the rotary shaft (4), the apparatus further comprising a seal member (5) for sealing the hub center hole (23c), the seal member (5) including a bottomed cylindrical fixed portion (5b) having a fitting hole (5a) fitted on the forward end portion (4a) of the rotary shaft (4) and a flange portion (5c) extending radially from the fixed portion (5b) to form, with the hub (2), a contact seal portion surrounding the hub center hole (23c). As a result, the contact seal portion is formed by the flange portion (5c) and the hub (2), and the seal member (5) is fitted on the rotary shaft (4) by the fixed portion (5b). Even in the case where the fixed portion (5b) is damaged at the time of pressure fitting, the sealability against the hub center hole (23c) is not adversely affected, thereby providing a reliable seal structure.

According to a second aspect of the invention, there is provided a power transmission apparatus, wherein the flange portion (5c) of the seal member (5) is in contact with the end surface (23h) of the hub (2) to which the hub center hole (23c) is open, so that the seal portion is formed. As a result, the contact seal portion can be formed by way of a simple structure of both the hub (2) and the seal member (5), thereby providing an inexpensive, reliable seal structure.

According to a third aspect of the invention, there is provided a power transmission apparatus, wherein at least one annular labyrinth groove is preferably formed on the surface (5d) of the flange portion (5c) forming the contact seal portion or the end surface (23h) of the hub, thereby providing a higher sealability.

According to a fourth aspect of the invention, there is provided a power transmission apparatus, wherein the flange portion (5c) is tilted in such a manner that the outer peripheral edge of the flange portion (5c) of the seal member (5) first comes into contact with the end surface (23h) of the hub (2) before fitting the seal member (5) at the forward end portion (4a) of the rotary shaft (4). Thus, a seal structure is realized which takes positive advantage of the elastic displacement of the flange portion (5c). As a result, the contact pressure of the contact seal portion is improved and the range in which dimensional errors of the seal member (5) and the hub (2) can be absorbed is increased, thereby achieving a higher sealability.

According to a fifth aspect of the invention, there is provided a power transmission apparatus, wherein the flange portion (5c) of the seal member (5) includes a cylindrical portion (5e) extending in the axial direction on the outer peripheral edge portion of the flange portion (5c), wherein the hub (2) includes an outer peripheral surface extending in the axial direction from the outer peripheral edge of the end surface (23h) to which the hub center hole (23c) is open, and wherein the inner peripheral surface (5f) of the cylindrical portion (5e) of the seal member (5) is in contact with the outer peripheral surface of the hub (2) thereby to form the contact seal portion. As a result, the cylindrical portion is fitted over the outer peripheral surface of the hub (2) and thus forms the contact seal portion. Therefore, the apparatus can withstand both high external and internal pressure acting so as to break the contact seal portion.

According to a sixth aspect of the invention, there is provided a power transmission apparatus, wherein the hub (2) has a limiter portion (23) at the central portion thereof for cutting off the transmission of excessive torque, and the hub center hole (23c) is formed in the limiter portion (23). This invention is especially preferable for application to the hub (2) having this torque limiter function to seal the hub center hole (23c) for stabilizing the friction coefficient of the screwed portion between the hub (limiter portion) and the rotary shaft (4).

According to a seventh aspect of the invention, there is provided a power transmission apparatus, wherein a similar effect to that described above can be obtained even in the case where the bottomed cylindrical fixed portion (5b) of the seal member (5) is fitted in the hub center hole (23c) in place of the forward end portion (4a) of the rotary shaft (4).

Incidentally, the reference numerals in the parentheses following the names of the respective means described above represent the correspondence with the specific means described below in the embodiments.

### BRIEF DESCRIPTION OF THE DRAWINGS

FIG. 1 is a longitudinal sectional view showing a power transmission apparatus according to a first embodiment of the invention.

FIG. 2 is an enlarged view of the essential parts of FIG. 1.

FIG. 3 is a diagram showing the longitudinal section and the side surface of a seal member of the power transmission apparatus according to the first embodiment of the invention.

FIG. 4 is a longitudinal sectional view showing a seal member of the power transmission apparatus according to a second embodiment.

FIG. 5 is a longitudinal sectional view showing a seal member and a limiter portion of the power transmission apparatus according to a modification of the second embodiment.

FIG. 6 is a longitudinal sectional view showing a seal member of the power transmission apparatus according to a third embodiment.

FIG. 7 is a longitudinal sectional view showing a seal member according to a modification of the third embodiment.

FIG. 8 is a longitudinal sectional view showing the essential parts of the power transmission apparatus according to a fourth embodiment.

FIG. 9 is a longitudinal sectional view showing a seal member according a modification of the fourth embodiment.

FIG. 10 is a longitudinal sectional view showing the essential parts of the power transmission apparatus according to a fifth embodiment.

FIG. 11 is a diagram showing the longitudinal section and the side surface of a seal member of the power transmission apparatus according to a sixth embodiment.

FIG. 12 is a diagram showing the longitudinal section and the side surface of a seal member of the power transmission apparatus according to a seventh embodiment.

FIG. 13 is a longitudinal sectional view showing the essential parts of the conventional power transmission apparatus.

The present invention may be more fully understood from the description of preferred embodiments of the invention, as set forth below, together with the accompanying drawings.

### DESCRIPTION OF THE PREFERRED EMBODIMENTS

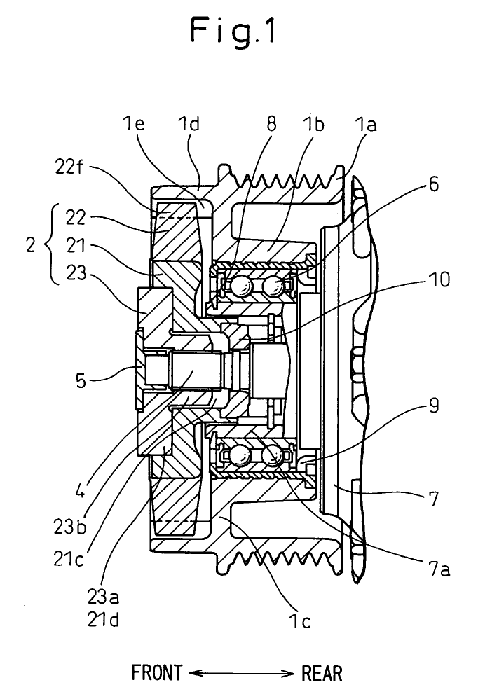

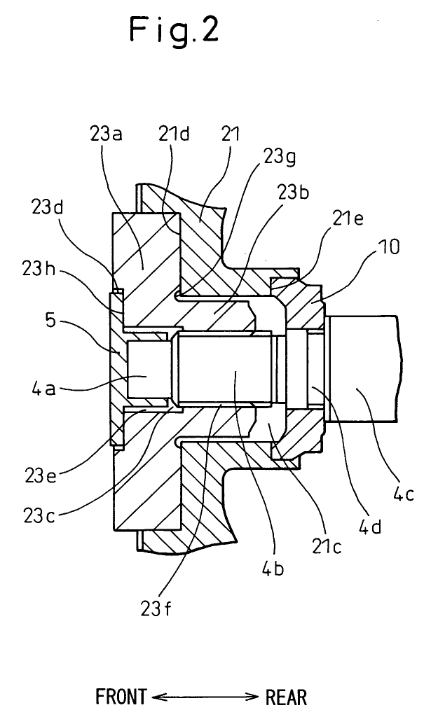

A first embodiment of the invention will be explained below with reference to the drawings. The power transmission apparatus according to this invention is preferably used by being assembled on the compressor of the air conditioning system of an automotive vehicle. The power transmission apparatus according to this invention, though explained below as assembled on the compressor, is appropriately applicable also to rotary machines other than the compressor with equal effect. FIG. 1 is a longitudinal sectional view of the power transmission apparatus according to a first embodiment of the invention, and FIG. 2 an enlarged view of the essential parts of FIG. 1.

The power transmission apparatus according to this invention includes a pulley 1 constituting a driving rotary member for receiving the drive force from an engine or a motor and a hub 2 constituting a driven rotary member coupled to the pulley 1 by spline coupling and fixed on the rotary shaft 4 of the compressor to transmit the power (torque) to the rotary shaft 4. The power transmission apparatus according to this invention further includes a seal member 5 mounted at the forward end of the rotary shaft 4. The pulley 1, the hub 2 and the seal member 5 are mounted on the same axis.

As shown in FIG. 1, the pulley 1 according to this embodiment includes a rim portion 1a with a belt (not shown) wound on the outer periphery thereof for receiving the power, an annular rib portion 1b extending axially in ring form to hold the bearing 6 while at the same time improving the rigidity of the pulley 1, a discal portion 1c for coupling the rim portion 1a and the annular rib portion 1b and a cylindrical portion 1d having substantially the same outer diameter as the rim portion 1a and formed nearer the front side than the discal portion 1c. The pulley 1 is mounted rotatably on a boss portion 7a formed at one end of the compressor casing 7, through the bearing 6 and a collar 8 with a sleeve ring. This pulley 1 is preferably formed of a thermosetting synthetic resin. Normally, the pulley 1, the collar 8 with a sleeve ring and the bearing 6 are integrated with each other by insertion molding. A belt (not shown) is wound on the outer peripheral surface of the rim portion la of the pulley 1, which in turn is rotated by the power supplied from an external source such as an engine or a motor. The bearing 6 is prevented from moving in the axial direction by the collar 8 (snap ring) with a sleeve ring fitted in the groove formed on the outer peripheral surface of the boss portion 7a, an end portion of the boss portion 7a and a ring member 9 fitted in the collar 8. The casing 7 and the rotary shaft 4 are hermetically sealed by a shaft-sealing unit thereby to prevent the refrigerant or oil from leaking outside. This shaft-sealing unit is also prevented from moving in the axial direction by another collar (snap ring) fitted in the groove formed on the inner peripheral surface of the boss portion 7a.

The rotary shaft 4 of the compressor projects toward the front side in FIG. 2 from the casing 7, and includes a forward end portion 4a having a comparatively small diameter, a male screw portion 4b formed with an externally threaded portion on the outer periphery thereof, an intermediate shaft portion 4d free of screw thread and a large-diameter shaft portion 4c having the largest diameter in that order from the forward end. A washer 10 is inserted on the intermediate shaft portion 4d, and held between the rear-side surface of the hub 2 and a stepped portion formed between the intermediate shaft portion 4d and the large-diameter shaft portion 4c. According to the first embodiment, the forward end portion 4a has a circular cross section.

Next, the hub 2 will be explained. The hub 2 is composed of an inner hub 21, an outer hub 22 used for torque transmission and buffering and formed of an elastic material such as rubber bonded by a bonding means on the outer periphery of the inner hub 21, and a limiter portion 23 having the torque limiter function mounted on the inner periphery of the inner hub 21. Incidentally, the torque limiter function is intended to protect the belt and the like from excessive torque generated, for example, by the seizing of the compressor. The inner hub 21 has at the center thereof an insertion hole 21c into which the small-diameter shaft portion 23b of the limiter portion 23 is inserted, and the front-side end surface of the inner hub 21 is formed with a hub circular depression 21d adapted to receive a hexagonal flange portion 23a of the limiter portion 23 fitted therein.

The limiter portion 23 assumes a stepped form including the large-diameter hexagonal flange portion 23a and the small-diameter shaft portion 23b. A circular depression 23d and a hub center hole 23c which is a through hole are formed at the center of the front-side end surface of the flange portion 23a. The hub center hole 23c includes a front-side unthreaded portion 23e and a rear-side internally threaded portion 23f. The intermediate portion between the flange portion 23a and the small-diameter shaft portion 23b is formed with an annular notch portion 23g. This annular notch portion 23g is formed in such a manner as to break under the axial force derived from excessive torque which may act on the limiter portion 23.

The outer hub 22 is substantially cylindrical and includes a hub-side concavo-convex portion 22f formed on the outer periphery thereof and a coupling hole formed at the center thereof to couple with the inner hub 21. The hub-side concavo-convex portion 22f of the outer hub 22 includes a series of concavo-convex portions arranged in annular form with the hub axis as a center, and is formed so as to be fitted on the pulley-side concavo-convex portion 1e having a series of concavo-convex portions formed on the inner peripheral surface of the cylindrical portion 1d of the pulley 1.

In fixing the hub 2 on the rotary shaft 4, the hexagonal flange portion 23a of the limiter portion 23 is fitted in the hub circular depression 21d, after which the internally threaded portion 23f formed in the hub center hole 23c of the limiter portion 23 is screwed to the externally threaded portion 4b of the rotary shaft 4. In the process, the inner hub 21 receives the force from the flange portion 23a of the limiter portion 23, so that the rear-side bearing surface 21e is pressed against the front-side end surface of the washer 10. Thus, the inner hub 21 is fixed indirectly on the rotary shaft 4, and consequently the whole hub 2 is fixed on the rotary shaft 4. The power transmission apparatus according to this embodiment is constructed as described above, and therefore can transmit the torque from the pulley 1 to the rotary shaft 4 through the hub 2.

In forcing the limiter portion 23 into the rotary shaft 4, an oil or the like is normally coated on the internally threaded portion 23f and the externally threaded portion 4b. By coating an oil or the like in this way, the friction coefficient of the threaded portions 23f, 4b is reduced and stabilized, thereby making it possible to suppress variation in torque which could break the annular notch portion 23g.

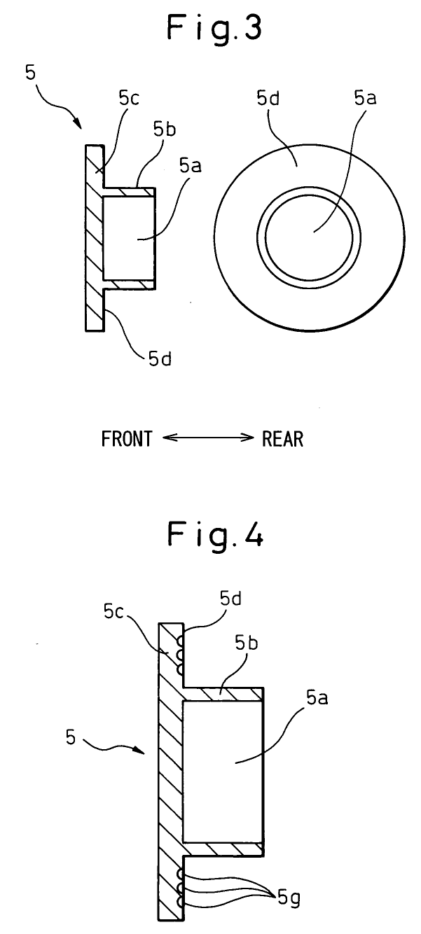

Next, the seal member 5 of the power transmission apparatus according to the first embodiment will be explained with reference to FIG. 2 and FIG. 3 including the longitudinal sectional view and the rear side view of the seal member 5. The seal member 5 is integrally formed of a bottomed cylindrical fixed portion 5b having a fitting hole 5a fitted on the forward end portion 4a of the rotary shaft 4 and a flange portion 5c extending in radial direction. The fitting hole 5a has a circular cross section corresponding to the forward end portion 4a of the rotary shaft 4 on the one hand and a slightly smaller inner diameter than the outer diameter of the forward end portion 4a on the other hand. When mounting the fixed portion 5b at the forward end portion 4a, therefore the fitting hole 5a, slightly increased in diameter, is press fitted on and held by the forward end portion 4a. The flange portion 5c is formed in such a size that the outer diameter thereof is fitted in the circular depression 23d of the limiter portion 23. The seal member 5 according to this embodiment, though formed of a rubber-like elastic material, may alternatively be formed of a metal or a synthetic resin material. This is also the case with the seal member according to second to seventh embodiments described later.

The seal member 5 is formed in such a manner that when the fixed portion 5b is inserted fittingly to a predetermined position onto the forward end portion 4a of the rotary shaft 4, the rear-side surface 5d of the flange portion 5c comes into contact with the bottom surface 23h of the circular depression 23d of the limiter portion 23. The hub center hole 23c is open to the bottom surface 23h, and when the seal member 5 is mounted on the rotary shaft 4, a contact seal portion surrounding the hub center hole 23c is formed between the flange portion 5c and the bottom surface 23h thereby to seal the hub center hole 23c. According to this invention, the circular depression 23d is not essential, and the end surface to which the hub center hole 23c is open may be a flat surface lacking the circular depression 23d.

Next, the power transmission apparatus according to a second embodiment will be explained. The power transmission apparatus according to the second embodiment, though having a seal member different from that of the first embodiment in the points described below, has the same other component elements as the first embodiment. The seal member 5 according to this embodiment, as shown in the longitudinal sectional view of FIG. 4, like the seal member 5 according to the first embodiment, includes a bottomed cylindrical fixed portion 5b fitted on the forward end portion 4a of the rotary shaft 4 and a flange portion 5c in contact with the front-side end surface 23h of the limiter portion 23. However the seal member 5 according to this embodiment is different from the seal member 5 of the first embodiment in that in this embodiment, three annular labyrinth grooves 5g are formed concentrically on the rear-side surface 5d of the flange portion 5c. The sealing effect of the seal member 5 according to this embodiment is further improved by the labyrinth grooves 5g. According to this invention, the number of the labyrinth grooves 5g is not limited to three but may be any number not less than unity.

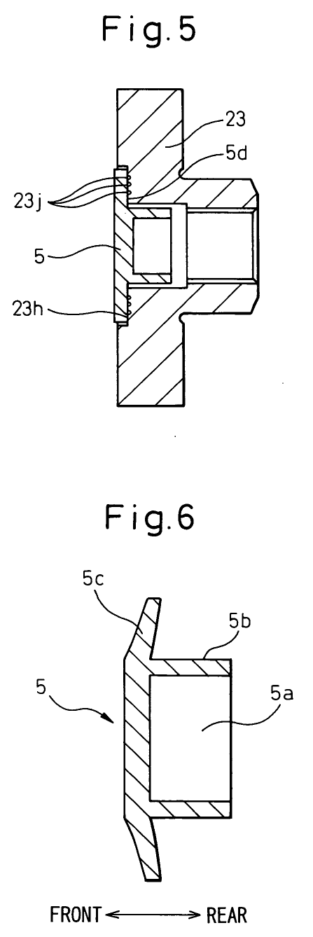

Next, the power transmission apparatus according to a modification of the second embodiment will be explained. According to this modification, as understood from the longitudinal sectional view of FIG. 5 showing the limiter portion 23 and the seal member 5, the seal member 5 is similar to the corresponding one of the first embodiment, except that the bottom surface 23h of the circular depression 23d of the limiter portion 23, i.e. the surface in contact with the rear-side surface 5d of the seal member 5 is formed with three annular labyrinth grooves 23j concentrically.

Next, the seal member 5 of the power transmission apparatus according to the third embodiment will be explained with reference to the longitudinal sectional view of FIG. 6. The seal member 5, like in the first embodiment, includes a flange portion 5c and a bottomed cylindrical fixed portion 5b. The outer peripheral edge portion of the flange portion 5c is tilted rearward. When the seal member 5 is inserted at the forward end portion 4a of the rotary shaft 4, therefore the outer peripheral edge portion of the flange portion 5c first comes into contact with the circularly depressed bottom surface 23h of the limiter portion 23d. The tilt angle and the modulus of section of the flange portion 5c are determined in such a manner as to secure a predetermined displacement within the range of elastic deformation when the seal member 5 is inserted to a predetermined position onto the rotary shaft 4. When the seal member 5 is inserted to the predetermined position onto the forward end portion 4a, the contact portion of the flange portion 5c therefore applies pressure to the end surface 23h of the limiter portion 23 based on the force corresponding to the deflection of the flange portion 5c.

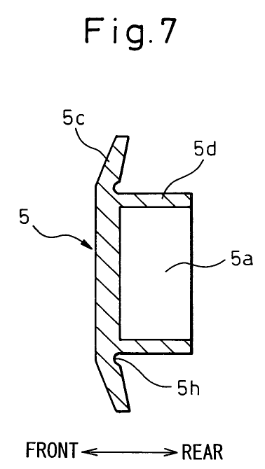

The seal member 5 of the power transmission apparatus according to still another modification of the third embodiment will be explained with reference to the longitudinal sectional view of FIG. 7. The seal member 5 has a root R portion 5h to reduce the stress concentration at the base of the flange portion 5c of the seal member 5 according to the third embodiment, i.e. the intermediate portion between the fixed portion 5b and the flange portion 5c.

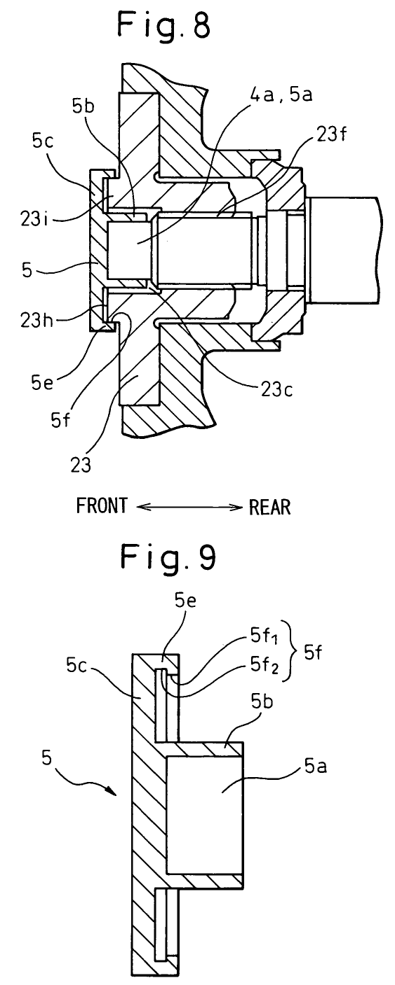

Next, the power transmission apparatus according to a fourth embodiment will be explained with reference to the longitudinal sectional view of FIG. 8 showing the essential parts thereof. The limiter portion 23 of the hub 2 of the power transmission apparatus according to this embodiment, like the limiter portion 23 of the aforementioned embodiments, includes a hub center hole 23c formed with an internally threaded portion 23f, but does not have a circular depression 23d. Instead, the limiter portion 23 according to this embodiment is configured so that the front-side end surface 23h to which the hub center hole 23c is open projects in circular form around it thereby to form a circular protrusion 23i. The seal member 5 according to this embodiment, like the seal member 5 according to the first embodiment, includes a bottomed cylindrical fixed portion 5b formed with a fitting hole 5a fitted on the forward end portion 4a of the rotary shaft 4 and a flange portion 5c extending in radial direction. The flange portion 5c has a cylindrical portion 5e extending in axial direction on the outer peripheral edge portion thereof. This cylindrical portion 5e is formed in such a manner that the inner diameter thereof is slightly smaller than the outer diameter of the circular protrusion 23i of the limiter portion 23.

With this configuration, in the case where the fixed portion 5b of the seal member 5 is fitted by being inserted to a predetermined position on the forward end portion 4a of the rotary shaft 4, the inner peripheral surface 5f of the cylindrical portion 5e comes into contact with the outer peripheral surface of the circular protrusion 23i of the limiter portion 23, so that a contact seal portion is formed thereby to seal the hub center hole 23c.

Next, the seal member according to a modification of the fourth embodiment described above will be explained with reference to the longitudinal sectional view of FIG. 9. The inner peripheral surface 5f of the cylindrical portion 5e of this seal member is composed of a first inner peripheral surface 5f1 comparatively small in diameter in contact with the outer peripheral surface of the circular protrusion and a second inner peripheral surface 5f2 having a comparatively large diameter not in contact with the outer peripheral surface of the circular protrusion. The first inner peripheral portion 5f1 is located nearer to the free end of the cylindrical portion 5e than the second inner peripheral surface 5f2.

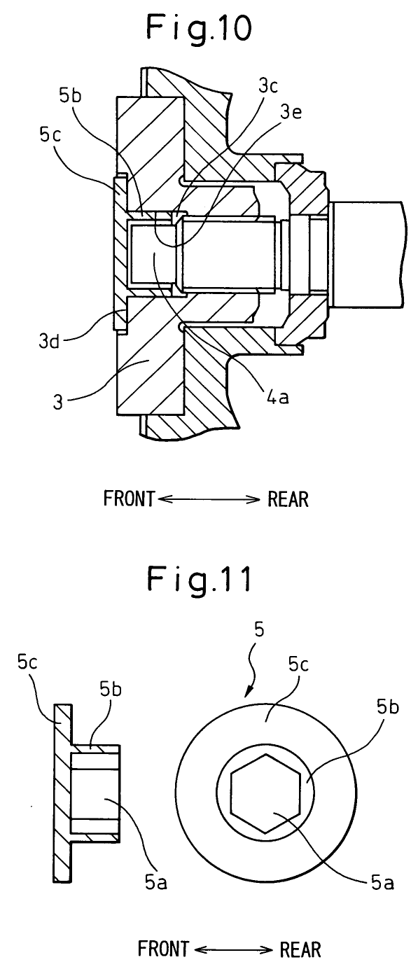

Next, the seal member 5 of the power transmission apparatus according to a fifth embodiment will be explained with reference to FIG. 10. The seal member 5 according to the fifth embodiment, similar in appearance to the seal member 5 of the first embodiment described above, is integrally formed of a bottomed cylindrical fixed portion 5b and a flange portion 5c extending in radial direction. However, the fixed portion 5b of the seal member 5 according to the fifth embodiment has an outer diameter slightly larger than the inner diameter of the unthreaded portion 23e in such a manner that the seal member 5 may be fitted, not on the forward end portion 4a of the rotary shaft 4, but on the unthreaded portion 23e of the hub center hole 23c of the limiter portion 23. The fitting hole 5a of the fixed portion 5b of the seal member 5 is formed in such a manner that the inner diameter thereof is larger than the outer diameter of the forward end portion 4a of the rotary shaft, and therefore the fitting hole 5 and the forward portion 4a are out of contact with each other. With this configuration, when the seal member 5 is fitted in the hub center hole 23c, a contact seal portion surrounding the hub center hole 23c is formed between the flange portion 5c and the bottom surface 23h of the circular depression 23d thereby to seal the hub center hole 23c.

According to this invention, the flange portion 5c of the seal member 5 according to the fifth embodiment, like the flange portion 5c of the seal member 5 according to the third embodiment, may be tilted or, like the seal member 5 of the fourth embodiment, may be provided with a cylindrical portion 5e. In this way, the contact seal portion can be formed.

Next, the seal member 5 of the power transmission apparatus according to a sixth embodiment will be explained with reference to FIG. 11 including a longitudinal sectional view and a rear side view. The seal member 5 according to this embodiment, like in the first embodiment, includes a flange portion 5c and a bottomed cylindrical fixed portion 5b. However, the fitting hole 5a has a regular hexagonal cross section due to the fact that according to the sixth embodiment, the cross section of the forward end portion 4a of the rotary shaft 4 is a regular hexagon. The regular hexagon of the fitting hole 5a is slightly smaller than the regular hexagon of the forward end portion 4a to permit the fitting hole 5a to be fitted on the forward end portion 4a.

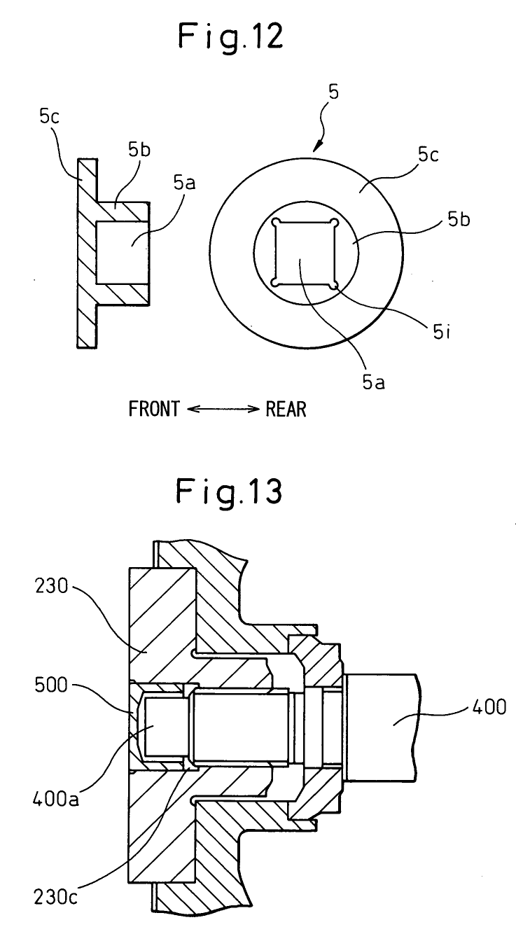

Next, the seal member 5 of the power transmission apparatus according to a seventh embodiment will be explained with reference to FIG. 12 including a longitudinal sectional view and a rear side view thereof. The fitting hole 5a of the seal member 5 according to this embodiment has a square cross section due to the fact that the cross section of the forward end portion 4a at the forward end of the rotary shaft 4 according to this embodiment is a square. The square of the fitting hole 5a is slightly smaller than the square of the forward end portion 4a to permit the fitting hole 5a to be fitted on the forward end portion 4a. The adjoining sides of the square are connected to each other by an arc 5i projecting outside beyond the width of the square to reduce the stress concentration at the four corners.

According to the sixth and seventh embodiments, the fitting hole 5a of the seal member 5 has a regular hexagonal cross section and a square cross section, respectively. However according to this embodiment the cross section of the fitting hole 5a may have other shapes, such as a regular polygon or a polygon, and a modification of the seventh embodiment lacking the arc 5i is also applicable.

While the invention has been described by reference to specific embodiments chosen for purposes of illustration, it should be apparent that numerous modifications could be made thereto by those skilled in the art without departing from the basic concept and scope of the invention.

1. A power transmission apparatus comprising:
a pulley mounted rotatably on a casing of a rotary machine having a rotary shaft, the rotary shaft including an externally threaded portion formed on the part projecting out of said casing of said rotary machine; and
a hub coupled to said pulley in such a manner as to transmit the torque to said pulley, the hub including a hub center hole having an internally threaded portion formed along the axis of said hub,
wherein said internally threaded portion is screwed to said externally threaded portion of said rotary shaft thereby to be coupled to said rotary shaft,
the apparatus further comprising a seal member for sealing said hub center hole, the seal member including a bottomed cylindrical fixed portion having a fitting hole fitted on the forward end portion of said rotary shaft and a flange portion extending radially from said fixed portion to form, with said hub, a contact seal portion surrounding said hub center hole.

2. The power transmission apparatus as set forth in claim 1, wherein said contact seal portion is formed by said flange portion of said seal member in contact with the end surface to which said hub center hole is open.

3. The power transmission apparatus as set forth in claim 2, wherein said seal member has at least one annular labyrinth groove formed on the surface of said flange portion forming said contact seal portion.

4. The power transmission apparatus as set forth in claim 2, wherein said hub has at least one annular labyrinth groove on the end surface forming said contact seal portion.

5. The power transmission apparatus as set forth in claim 2, wherein said flange portion is tilted in such a manner that said outer peripheral edge of said flange portion of said seal member first comes into contact with said end surface of said hub at the time of fitting said seal member on the forward end portion of said rotary shaft.

6. The power transmission apparatus as set forth in claim 5, wherein a curved root portion for reducing stress concentration is formed at the intermediate portion between said fixed portion and said flange portion.

7. The power transmission apparatus as set forth in claim 1, wherein said flange portion of said seal member includes a cylindrical portion extending in the axial direction on the outer peripheral edge of said flange portion,
wherein said hub includes an outer peripheral surface extending in the axial direction from the outer peripheral edge of the end surface to which said hub center hole is open, and
wherein the inner peripheral surface of the cylindrical portion of said seal member is in contact with said outer peripheral surface of said hub thereby to form said contact seal portion.

8. The power transmission apparatus as set forth in claim 7, wherein the inner peripheral surface of said cylindrical portion of said seal member comprises a first inner peripheral surface comparatively small in diameter in contact with the outer peripheral surface of said hub and a second inner peripheral surface comparatively large in diameter not in contact with the outer peripheral surface of said hub, and the first inner peripheral surface is formed nearer the free end of said cylindrical portion than the second inner peripheral surface.

9. The power transmission apparatus as set forth in claim 1, wherein said hub comprises, at the central portion thereof, a limiter portion for cutting off the transmission of excessive torque, and said hub center hole is formed in said limiter portion.

10. The power transmission apparatus as set forth in claim 1, wherein said fixed portion of said seal member is fitted in said hub center hole in place of said forward end portion of said rotary shaft.

11. The power transmission apparatus as set forth in claim 1, wherein the shape of the cross section of the forward end portion of said rotary shaft is a hexagon, and the shape of the cross section of said fitting hole of said fixed portion of said seal member is such a hexagon that said fixed portion is fitted on said forward end portion of said rotary shaft.

12. The power transmission apparatus as set forth in claim 1, wherein the shape of said cross section of the forward end portion of said rotary shaft is a rectangle, and wherein the shape of the cross section of said fitting hole of said fixed portion of said seal member is such a rectangle that said fixed portion is fitted on said forward end portion of said rotary shaft on the one hand, and the adjoining sides of said rectangle are connected by an arc projecting outside of the length and the width of said rectangle on the other hand.
